(19) United States
(12) Patent Application Publication
(10) Pub. No.: US 2012/0133156 A1
(43) Pub. Date: May 31, 2012

(54) Panic Hardware Dogging Release Device

(76) Inventors: Scott Christopher Tillman, Brazil, IN (US); Jeffrey Edward Bensinger, Terre Haute, IN (US)

(21) Appl. No.: 13/251,579

(22) Filed: Oct. 3, 2011

Related U.S. Application Data
(60) Provisional application No. 61/458,634, filed on Nov. 29, 2010.

(51) Int. Cl. E05C 19/00

(52) U.S. Cl. 292/80

(57) ABSTRACT

An apparatus kit which releases the dogging function of a panic device without the use of a key or other external device comprising: an end cap button; connecting adjustable rod; and an adaptable linkage to the existing dogging mechanism of the panic devise.

### REFERENCES CITED

### US Patent Documents

| | | |
|---|---|---|
| 4,466,643 | August 1981 | Godec |
| 4,968,070 | August 1989 | Choi |
| 5,016,927 | October 1990 | Toledo |
| 5,184,852 | July 1991 | O'Brien |
| 5,927,765 | December 1997 | Austin et al. |

### BACKGROUND OF THE INVENTION

1. Field of the Invention

This patent relates to the field of door security systems. More specifically, this invention provides an added function to the existing panic device by releasing the dogging mechanism without the use of an external key or similar owner required device.

2. Description of the Related Art

Door exit devices, also referred to as panic exits or fire exits, are typically operated from the inside of an outward swinging door and are designed to provide building occupants fast and easy egress in an emergency. A door exit device generally comprises a manually actuated latch release mechanism releasing a door latch responsive to a relatively minimal force applied in the direction of egress travel through the doorway. The manually actuated release mechanism includes a readily accessible push pad or crossbar rail extending at least halfway across the width of the door.

With safety of building occupants as its primary function, a door exit device must always release the door latch, allowing exit without special access authorization or significant door operation knowledge. Any minimally sufficient horizontal push force applied to the outer vertical surface of a push pad type exit device retracts the latch bolt and releases the door to be opened. Several exit device designs have been designed and utilized including rim type, vertical rod, and mortise lock type devices.

Many of these panic devices have a dogging function which allows the panic device to be intentionally placed into an unlocked and unsecure position. This is achieved by means of a cylinder or hex key latching of the panic device when in the depressed push pad state.

Currently the functionality will only allow the Panic Device Hardware to be locked/unlocked by means of this Hex key or Cylinder Key. This new proposed functionality will allow the locking of the Panic Device Hardware in a Quick manner without the need of a Hex Key or Cylinder Key.

The benefits of this added functionality will allow any individual the ability to lock the Panic Device Door without the need for a Hex Key or Cylinder Key. This would provide an added security to the door if a need arises requiring the immediate securing of the door. Currently only building owners with the Hex Key or Cylinder Key could lock the Panic Hardware Door if the Panic Device is in the Dogged Down (always unlocked) position.

There remains a need for an exit device apparatus, system and method that efficiently and quickly releases the dogging function of the panic device. The present invention addresses such a need and other needs not addressed by the prior art.

### SUMMARY OF THE INVENTION

A door exit device, security, and method for releasing the dogging function of the panic device in a quick and efficient manner without the need of a key of other mechanical device. The Quick Panic Release device provides securing of a door into the locked position with a depressing of the end cap button. This depressing of the button actuates and releases the dogging function whereby providing the door to be secure and in a locked mode from the exterior side of the device. Exiting the door from within is still allowed as normally intended by depressing of the panic device bar. The panic device will remain in the locked position and access back in through the door will only be granted by those in possession of a key to the rim cylinder lock.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a plan view of a door exit device in accordance with one embodiment of the present invention in the Dogged (unlocked) position;

FIG. 2 depicts a plan view of a door exit device in accordance with one embodiment of the present invention in the Un-Dogged (locked) position;

FIG. 3 illustrates a cutaway 3D view of the door exit device of the present invention in the Dogged (unlocked) position;

FIG. 4 illustrates a cutaway 3D view of the door exit device of the present invention in the Un-Dogged (locked) position

FIG. 5 illustrates the detail view of the end cap button and spring actuation;

FIG. 6 illustrates the detail view of the end cap button and spring actuation in the depressed state;

FIG. 7 illustrates the detail view of the Dogging latch connector;

### DETAILED DESCRIPTION OF ILLUSTRATIVE EMBODIMENT(S)

The present invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention. Furthermore, each Panic device manufacturer has variations of the latch mechanism by which the Dogging Function is achieved (diagram G). This invention is intended to apply to the desired means of releasing the Dogging Function and will require the connection to this latch to be adapted so as to provide this Quick Panic Release without compromising the existing function of the device.

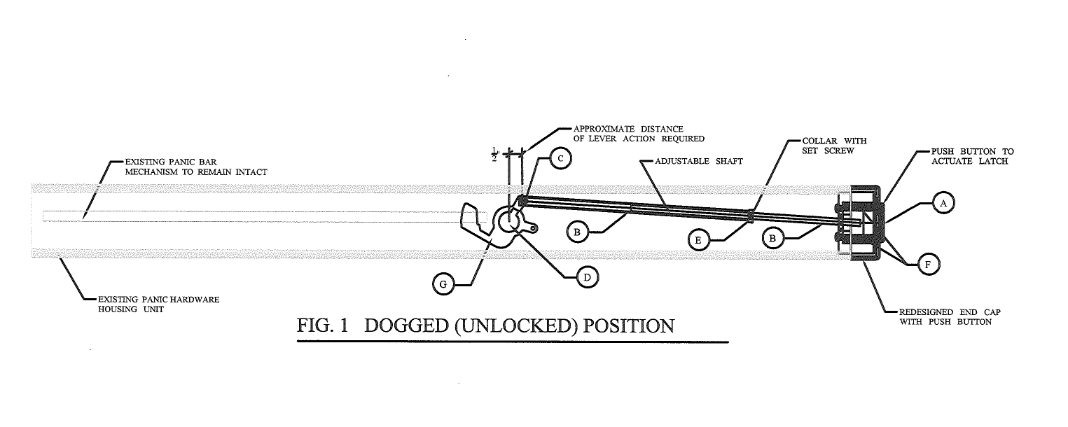

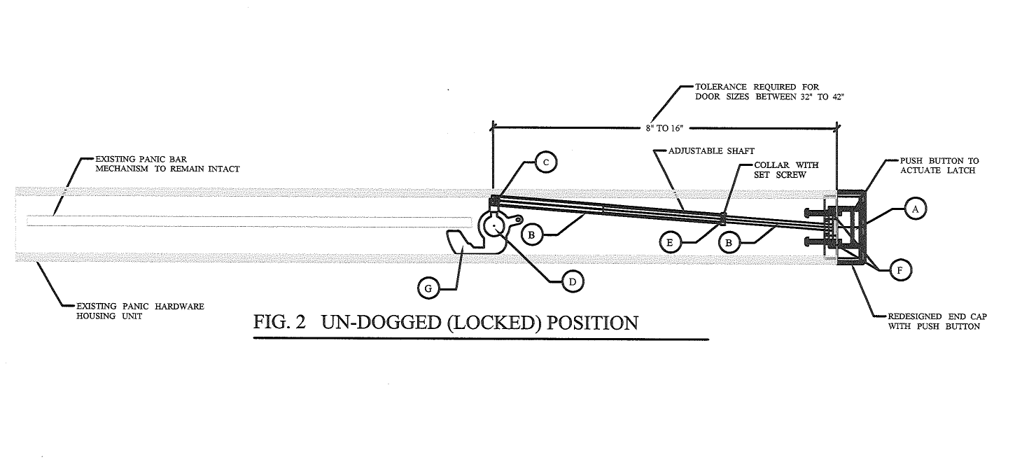

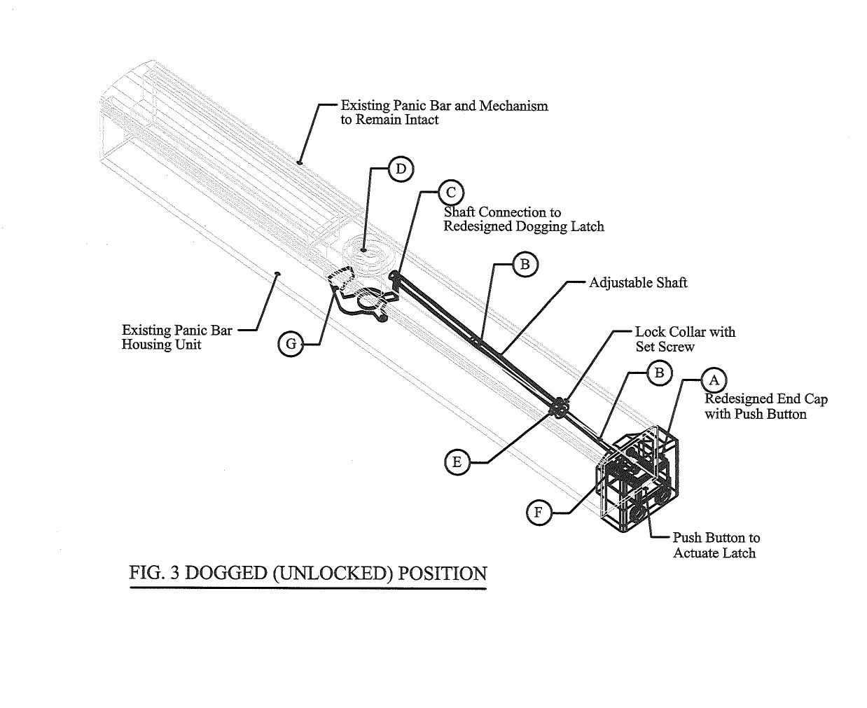

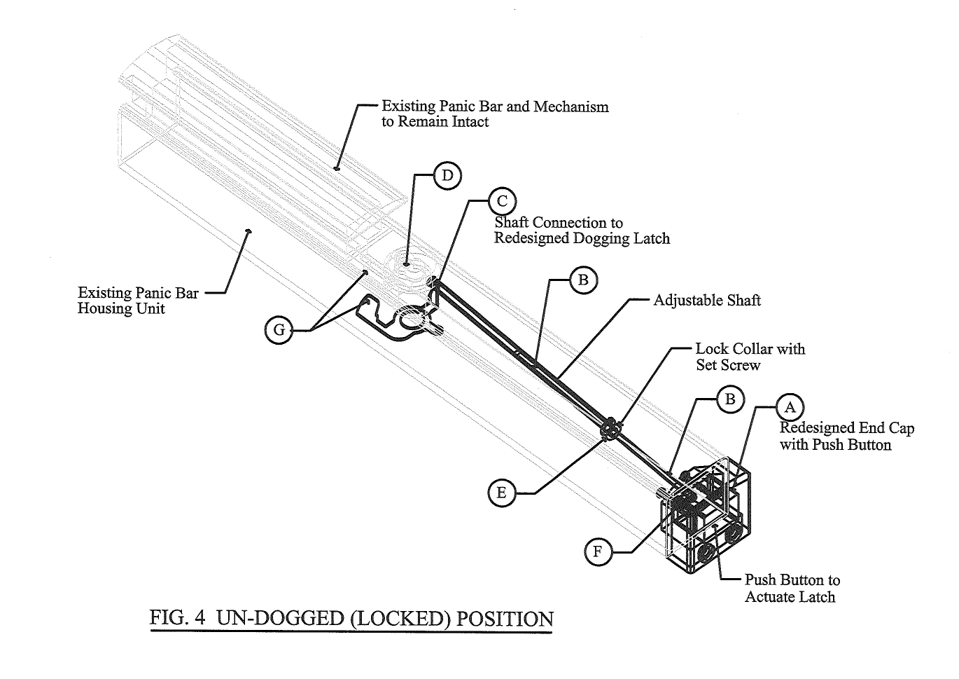

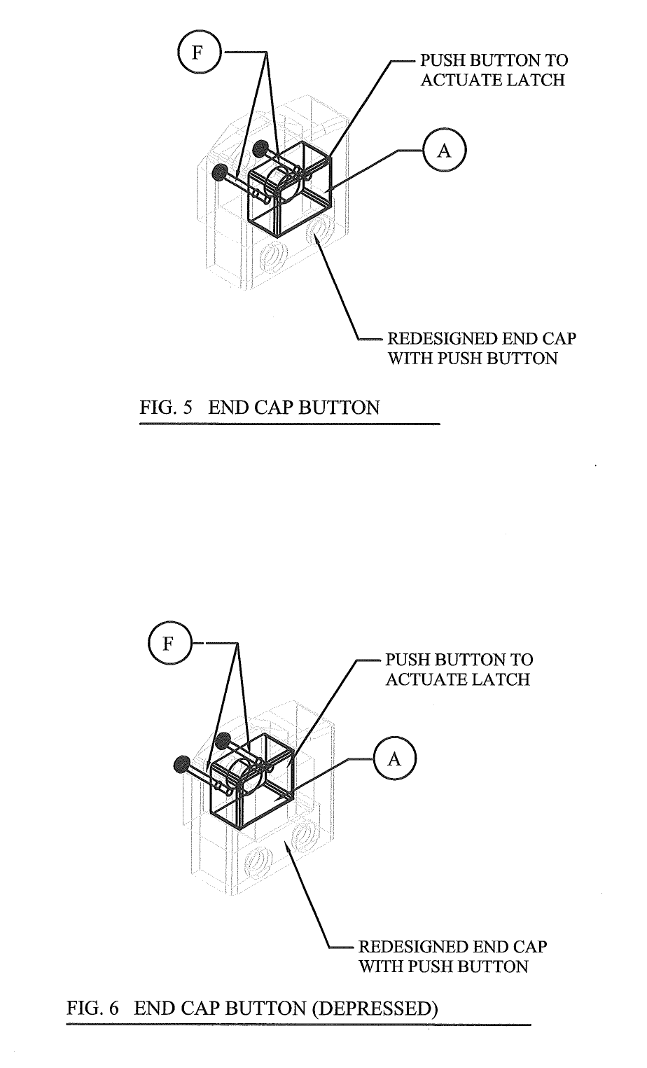

FIGS. 5 and 6; The Quick Latch Release functionality is achieved by the replacement of the existing end cap on the Panic device with a new end cap that has a built-in button (diagram A). An internal connecting shaft (diagram B) protrudes to back side of the button end cap through a hole.; This button has a pair of springs over two holding screws (diagram F) and by depressing the button, it places a force onto the connecting shaft and activates a lever (diagram D) that is connected to the locking/unlocking Dogging latch mechanism FIGS. 1 and 2; (diagram C). After the button is depressed, the springs force the button back to the original position. The internal connecting shaft and Dogging Latch remain in the pushed state as they are not mechanically connected to the button. The existing panic Dogging latch mechanism would be replaced with a new latch mechanism that allows a point of connection (diagram D) that facilitates the release of the dogging function of the Panic Bar. The pushing of the end cap button (diagram A) will only release the Dogging Function that keeps the Panic Bar in the always unlocked position (diagram G), whereby locking the panic door from outside of the room. The panic bar operation will continue to function as normal operation, whereby depressing the panic bar will open the door from the inside of the room. FIGS. 3 and 4; Reactivation of the Dogging Function will only be achieved by use of the existing “Hex Key” or “Cylinder Key” (diagram H), whereby only allowing authorized individuals to unlock “Dog Down” the Panic Device. This is critical in not allowing the door to be left unlocked by unauthorized persons.

FIGS. 3 and 4; The Panic Bar devices can be of various lengths which are determined by the size of the door and various manufacturers. These panic devices are field cut by the installer during the initial installation as per door size and site condition. To accommodate the variations in lengths, the connection shaft (Diagram B) from the push button (Diagram A) to the latch connection (Diagram D) needs to be adjustable. This can be achieved by a connection rod that fits inside a tube that would allow several inches of total connection length adjustment. A set collar with lock screw (Diagram E) would secure this rod and tube @ the appropriate length to facilitate the desired activation of the release of the Dogging latch mechanism.

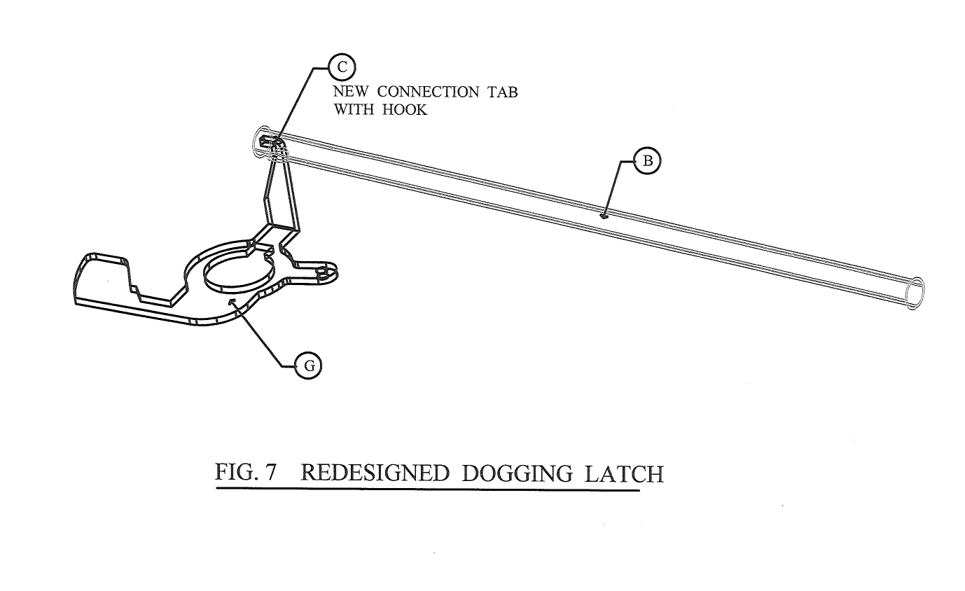

FIG. 7; The Redesigned dogging latch has a new connection tab lever (diagram C) which allows the adjustable tube (diagram B) to be attached over the hooked tab through a hole in the tube. The tube will apply a force to the lever, whereby rotating the dogging latch about the central axis of the latch and un-dogging the panic device. This un-dogging of the panic device is the new desired function of the Quick Panic Release invention.

This proposed invention will only require the replacement of two components of an existing panic bar device and the installation of the Quick Panic Release assembly. An existing Panic Devise could be modified with the Quick Panic Release assembly in a matter of minutes, whereby minimal labor costs would be involved in the retrofitting of an existing panic device that has a Dogging Function.

While the invention has been particularly shown and described with reference to a preferred embodiment, it will be understood by those skilled in the art that various changes in form and detail may be made therein without departing from the spirit and scope of the invention.

What is claimed is:

1-4. (canceled)

5. A dogging release assembly mechanism comprising:
an end cap button; an actuating adjustable rod; a set collar for rod length adjustment and a connection actuating linkage attached to the existing panic dogging latch. The dogging release assembly allows an existing panic hardware device to have an added functionality that allows the device to be un-dogged without needing a separate key to perform said un-dogging. The new invention end cap provides this un-dogging function by means of depressing the built-in button. The button actuates the existing panic device latch which holds the mechanism in the unlocked, dogged, position. This pressing of the button releases the dogging latch, whereby un-dogging the panic device and securing the door in a locked state from the exterior. An adjustable connection rod and a new latch linkage provide the button the needed connection to facilitate this desired un-dogging function.
